(19) United States
(12) Patent Application Publication
(10) Pub. No.: US 2017/0144602 A1
(43) Pub. Date: May 25, 2017

(54) STOWABLE LADDER SYSTEM

(71) Applicant: Kelly Industries, LLC, South Jordan, UT (US)

(72) Inventors: James E. Kelly, South Jordan, UT (US); Timothy R. Nieman, North Salt Lake, UT (US); Joshua C. Lund, Midvale, UT (US)

(73) Assignee: Kelly Industries, LLC, South Jordan, UT (US)

(21) Appl. No.: 14/948,533

(22) Filed: Nov. 23, 2015

(51) Int. Cl. B60R 3/00; B60R 3/02

(52) U.S. Cl. CPC B60R 3/005; B60R 3/02

(57) ABSTRACT

The embodiment enclosed relates to systems and methods for aiding a user in accessing the roof of a vehicle. The user may be accessing items stored on the roof, cleaning the roof, or otherwise performing some desired action relating to the roof of a vehicle. The embodiment may include a ladder which may attach to a roof rack system attached to a vehicle. The roof rack system may be installed by the manufacturer or may be a third party, aftermarket system. The ladder system may easily detach and attach to the roof rack system and may enable a user to access various portions of the roof. The ladder may store on proximate the roof when not in use and may enable a user to easily access the ladder when desired.

### BACKGROUND

Vehicles are used to transport cargo every day. Vehicles transport everything from sporting equipment to groceries to vacation items. To aid in the transport of items, vehicle users may opt to purchase roof racks with the vehicle and/or have an aftermarket roof rack system installed on the vehicle. The roof rack system may enable the transport of a plethora of items.

A vehicle may have a transportation cargo pod installed as part of the roof rack system. The transportation cargo pod may provide additional storage space to the vehicle user. The roof rack system may enable transportation of bicycles, snow equipment, water equipment, etc. However, the roof rack system may be difficult to access. A height differential between the user and the vehicle may make the roof rack system unmanageable. A user may have to climb onto/into the vehicle to reach the roof. This may result in the user opening a passenger and/or driver door and stepping on the seat of the vehicle and/or potentially damaging the seat and/or the side of the vehicle and/or the exterior. If the weather is cold or hot, climbing on the seats may allow exterior air to enter a vehicle causing discomfort to passengers. In inclement weather, this may damage the interior of the car.

### SUMMARY

The embodiment enclosed relates to systems and methods for aiding a user in accessing the roof of a vehicle. The user may be accessing items stored on the roof, cleaning the roof, or otherwise performing some desired action relating to the roof/upper exterior area of a vehicle. The embodiment may include a ladder which may attach to a roof rack system attached to a vehicle. The roof rack system may be installed by the manufacturer or may be a third party, aftermarket system. The ladder system may easily detach and attach to the roof rack system and may enable a user to access various portions of the roof. The ladder may store in proximity to the roof when not in use and therefore? may enable a user to easily access the ladder when desired.

In one embodiment, an apparatus for accessing a roof of a vehicle is described. The apparatus comprises a first attachment system coupled to a first load beam of a roof rack system and a second attachment system coupled to a second load beam of a roof rack system. A rotatable beam is movably coupled to the first and second attachment system and a collapsible ladder is coupled to the rotatable beam.

The first attachment system further comprises a first elongated member with a locking end, a second elongated member, and an elbow joint coupling the first elongated member and the second elongated member. A locking mechanism is proximate the locking end. The locking mechanism provides a friction fit between the first attachment system and the first load beam of the roof rack system. The locking mechanism further comprises a tightening member, a handle coupled to a first end of the tightening member, and a compression mechanism coupled to a second end of the tightening member. The handle is proximate the elbow joint and the tightening member passes through the elbow joint and first elongated member to connect to the compression mechanism proximate the locking end of the first elongated member.

In one instance, the collapsible ladder has a first position wherein the first position stores the ladder on the roof of the vehicle and a second position of the collapsible ladder, wherein the second position enables a user to deploy the ladder to access the roof. The ladder locks into place in a storage position. The collapsible ladder has a first length in the first position and a second length in the second position. The second length of the ladder is adjustable. In one instance, the collapsible ladder is a folding ladder. In another instance, the collapsible ladder is a telescoping ladder. The collapsible ladder has a curved profile. The rotatable member laterally slides between the first attachment system and the second attachment system.

In another embodiment, a ladder system for accessing a roof of a vehicle is described. The system comprises an attachment system coupled to a first and second load beam of a roof rack system. The attachment system comprises a first elongated member with a locking end, an extension member, a first elbow joint coupling the first elongated member and the extension member, a second elongated member with a locking end, and a second elbow joint coupling the second elongated member and the extension member. A rotatable beam is movably coupled to the extension member and a collapsible ladder coupled to the rotatable beam.

A first locking mechanism is proximate the locking end of the first elongated member, the first locking mechanism providing a friction fit between the first elongated member and the first load beam of the roof rack system. The first locking mechanism further comprises a tightening member, a handle coupled to a first end of the tightening member, and a compression mechanism coupled to a second end of the tightening member. The collapsible ladder has a first position, wherein the first position stores the ladder on the roof of the vehicle and a second position of the collapsible ladder, wherein the second position enables a user to deploy the ladder to access the roof. The collapsible ladder has a first length in the first position and a second length in the second position. The collapsible ladder has a curved profile.

In another embodiment, an apparatus for accessing a roof of a vehicle is described. The apparatus comprises a first attachment system coupled to a first load beam of a roof rack system. The first attachment system further comprises a first insertion beam with a locking end, a first extension beam, a first elbow joint coupling the first insertion beam and the first extension beam, and a locking mechanism proximate the locking end, the locking mechanism providing a friction fit between the first attachment system and the first load beam of the roof rack system. A second attachment system couples to a second load beam of a roof rack system. The second attachment system further comprises a second insertion beam with a locking end, a second extension beam, a second elbow joint coupling the second insertion beam and the second extension beam, and a locking mechanism proximate the locking end, the locking mechanism providing a friction fit between the second attachment system and the second load beam of the roof rack system. A rotatable beam is movably coupled to the first and second extension beams and a telescoping ladder coupled to the rotatable beam. The telescoping ladder comprises a first position of the collapsible ladder, wherein the first position stores the ladder on the roof of the vehicle and a second position of the collapsible ladder, wherein the second position enables a user to deploy the ladder to access the roof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an isometric view of an exemplary vehicle with a roof rack system;

FIG. 2 is a side view of a vehicle with an exemplary ladder system;

FIG. 3 is a front view of a vehicle with an exemplary ladder system;

FIG. 4 is a front view of a vehicle with an exemplary ladder system;

FIG. 5 is an isometric view of an exemplary ladder system;

FIG. 6 is an isometric view of an exemplary ladder system;

FIG. 7A is a top down view of an exemplary attachment system;

FIG. 7B is a cut-away view of an exemplary locking system in a load beam;

FIG. 8A is a top down view of an exemplary attachment system; and

FIG. 8B is a cut-away view of an exemplary locking system in a load beam.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein may, at least in part, relate to vehicles and roof rack systems. For the purposes of this disclosure, the term “aligned” means parallel, substantially parallel, or forming an angle of less than 35.0 degrees. Also, for the purposes of this disclosure, the term “transverse” means perpendicular, substantially perpendicular, or forming an angle between 55.0 and 125.0 degrees. Further, for purposes of this disclosure, the term “length” refers to the longest dimension of an object.

In some embodiments, vehicles are equipped with roof rack systems. The roof rack systems may be purchased by a third party provider and attached to the vehicle. A roof rack system may have at least two load beams. The loads beams may be hollow elongated members with a cap on opposing ends. The caps may be removable. To allow a person to access the roof, a collapsible ladder may be attached to an end of the load beams. The ladder may store easily on the roof but may be movable to allow a user to extend down the side of vehicle. The ladder may not touch the vehicle thus preventing possible damage such as scratching of the vehicle.

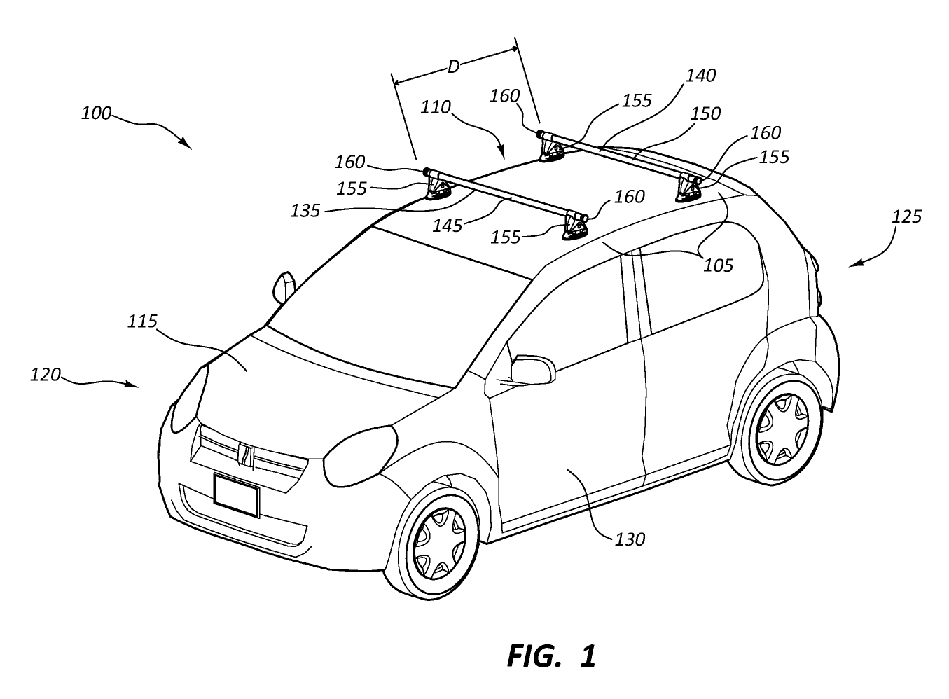

FIG. 1 is an isometric view of a vehicle 100 with a roof rack system 105 installed proximate the roof 110 of the vehicle. The vehicle 100 may comprise a standard size vehicle such as a coupe, sedan, wagon, hatchback, or the like. The vehicle 100 may also comprise a standard utility vehicle (SUV), crossover, truck, minivan, or the like. The vehicle 100 shown in FIG. 1 is merely representative of a generic vehicle and is not meant to limit the disclosure herein.

The vehicle 100 may include a body 115 of the vehicle 100 with a forward end 120 and a rear end 125 opposite the forward end 120. The vehicle 100 may include one or more doors 130. The roof 110 of the vehicle 100 may have a roof rack system 105 installed. In the embodiment shown, the roof rack system 105 may comprise a forward roof rack 135 and a rear roof rack 140. However, the roof rack system 105 may comprise additional racks as suitable. The forward and rear roof racks 135, 140 may comprise a load beam 145, 150 each with at least two attachment means 155 to the vehicle 100. The load beams 145, 150 may be substantially hollow and may include end caps 160 on the ends of the load beams 145, 150. The end caps 170 may be removable. The distance D between the roof racks 135, 140 may vary depending on the make and model of the vehicle 100 and number of roof racks installed.

The roof rack system 105 may allow the storage of cargo for transportation. The vehicle 100 may be equipped with an enclosed cargo box, snow equipment transportation, bicycle transportation, canoes, kayaks, and the like. However, accessing the roof 110 of the vehicle 100 can be difficult. The height difference between a person and the roof 110 may require a person to climb on the vehicle 100 to access the roof 110. Alternatively, a step stool or ladder may be used but the step stool or ladder may require transportation. The step stool or ladder may need to fit inside the vehicle 100. There may not be enough room in the vehicle 100 or the step stool or ladder may be dirty. Further, the ground on which an unsecured step ladder might rest could be fouled with snow, ice, mud, rocks, etc., making security of the ladder uncertain.

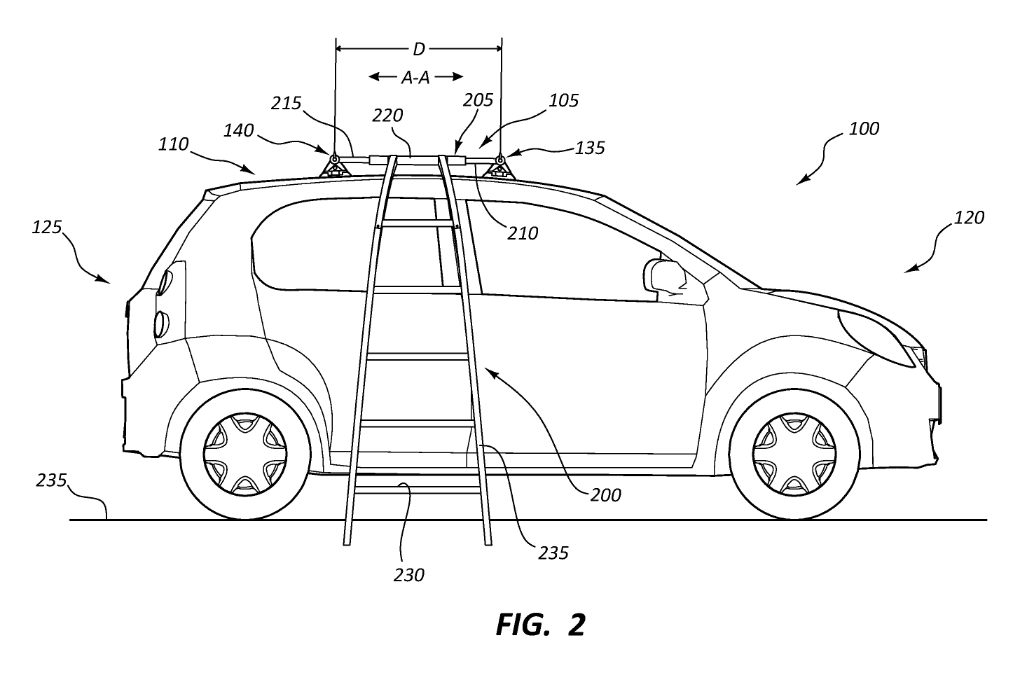

FIG. 2 is a side view of a vehicle 100 with a roof rack system 105 and ladder system 200 installed proximate the roof 110 of the vehicle. The ladder system 200 may enable a person to easily access the roof 110 of the vehicle 100. The ladder system 200 may include a cross-beam system 205 with a ladder 225 attached thereto. The ladder system 200 may attach to the roof rack system 105 and be mobile with the vehicle 100. The ladder system 200 may additionally be installed on other types of vehicles including a pop-up camper, a trailer, or any other item that may have a roof rack system 105 attached to it.

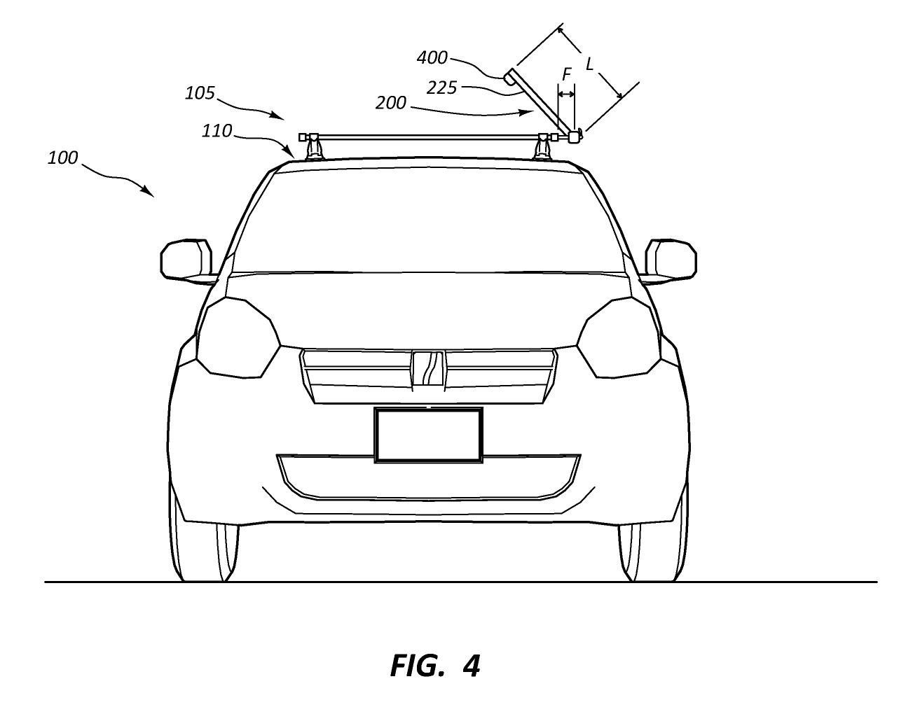

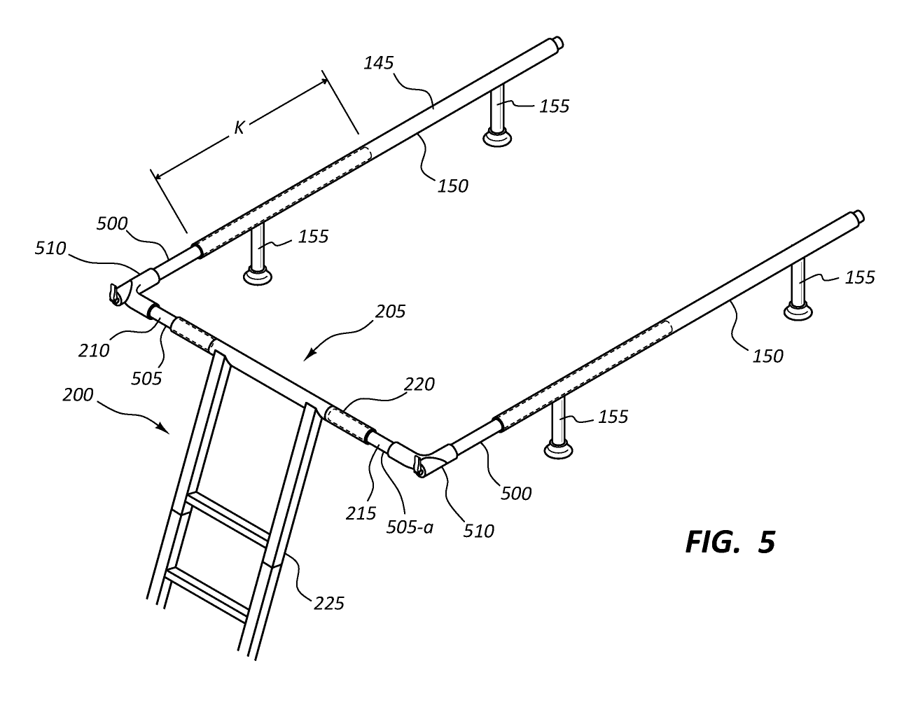

The cross-beam system 205, shown in greater detail in FIG. 5, may connect to the first roof rack 135 and the second roof rack 140 via one or more attachment means 210, 215 and may include a rotatable member 220 coupled to the collapsible ladder 225. The rotatable member 220 may enable the ladder 225 to rotate from a stored position (discussed with reference to FIG. 4) or an engaged position as shown in FIG. 2. The rotatable member 220 may also slide laterally between the attachments 210, 215 as indicated by arrows A-A. This may enable a user to easily access a more forward 120 or aft 125 part of the vehicle 100. As will be explained with greater detail below, the cross-beam system 205 may structurally connect the first roof rack 135 and the second roof rack 140. However, the distance D between the first roof rack 135 and the second roof rack 140 may not be equivalent for all make and model vehicles. Different vehicles may have different distances D between the two roof racks 135, 140. The cross-beam system 205 may have the ability to extend between the different distances D that may be present.

The ladder 225 is shown in an engaged position wherein the ladder 225 is accessible to climb and extends to, and rests upon, the ground 235. The ladder 225 may enable a person to climb up rungs 230 to a desired height to reach cargo that may be stored atop the roof 110. The rungs 230 may allow a person to load cargo or remove cargo from the roof 110, to clean the roof, or otherwise provide an added height to enable a person to perform a desired function.

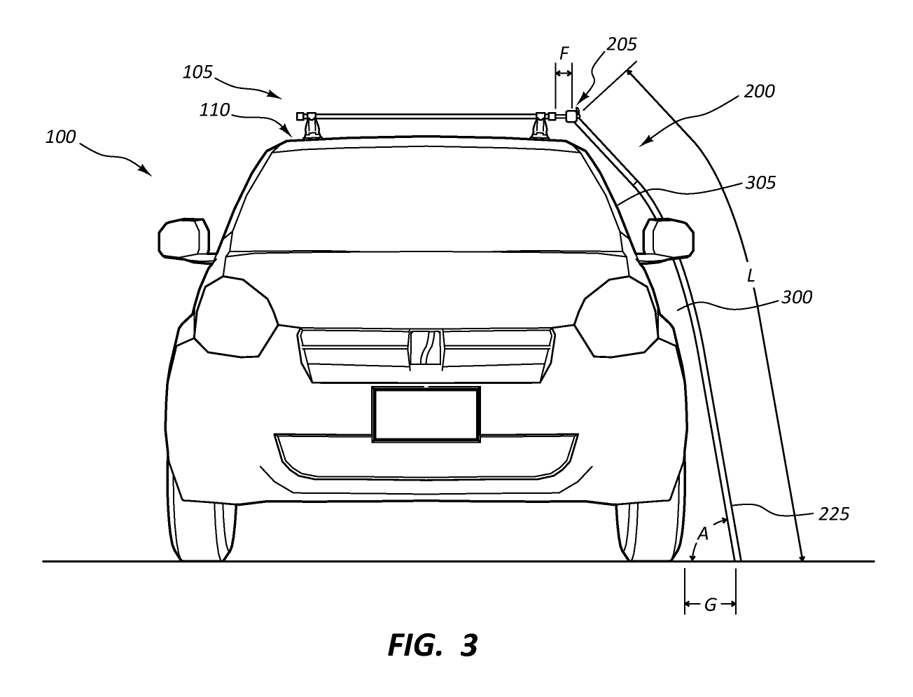

FIG. 3 shows a front view of a vehicle 100 with a roof rack system 105 and ladder system 200 installed proximate the roof 110 of the vehicle. FIG. 3 shows a gap 300 between the ladder 225 and the vehicle 100 wherein the ladder 225 is substantially aligned with a side 305 of the vehicle 100. The gap 300 may prevent the ladder 225 from scratching or otherwise damaging the sides 305 of the vehicle 100. The gap 300 may also enable a user to place their foot on the rung (e.g. rung 230, FIG. 2) of the ladder 225 to which may provide a sturdier climbing surface for the user.

The ladder 225 may have two adjustable distances which may affect the gap 300 between the vehicle 100 and the ladder 225. The first adjustable distance may be distance F. Distance F may be the distance the cross-beam system 205 is engaged with the roof rack system 105. The distance F may be negligible, or essentially zero. The distance F may also be expanded to create a more vertical angle A between the ground and the ladder 225. The vertical angle A may be a factor of the distance F and the distance G. If distance G remains constant, the vertical angle A will begin to reach ninety (90) degrees as the distance F is increased. Conversely, if the distance F is constant but the distance G is reduced, the vertical angle A will tend towards zero (0) degrees as the angle A is reduced. The ability to adjust the angle A of the ladder 225 may affect the sturdiness of the ladder 225. Adjusting the angle A may also adjust the gap 300 between the ladder 225 and the vehicle 100. In some instances, the distance G may be limited due to space surrounding the vehicle 100. For example, in a parking lot, a second vehicle may restrict movement on the side of the vehicle 100. Adjusting the distances F, G may also allow a person to safely engage the ladder 225, find sturdy ground, or comfortably adjust the ladder 225.

The ladder 225 as shown in FIG. 3 has a slight curvature side profile. The curvature profile may provide a more consistent gap 300 between the ladder 225 and the vehicle 100. While a slight curvature is shown, the curvature may vary from non-existent (i.e. a straight ladder) to a more curved side profile. In some embodiments, the curvature side profile may substantially align with the curvature of the side 300 of the vehicle 100.

The extended length L of the ladder 225 may also be adjustable depending on the vehicle on which the ladder 225 is attached and the ladder 225 itself. For example, the collapsible ladder 225 may be a telescoping ladder which may have a completely variable length that is fully customizable. The ladder 225 may additionally fold onto itself and may have varying lengths. If the ladder 225 is a foldable ladder, the distances F and G may provide the necessary adjustments for a sturdy ladder 225.

FIG. 4 is a front view of the vehicle 100 with a roof rack system 105 and ladder system 200 installed proximate the roof 110 of the vehicle. The ladder 225 is showed in a collapsed, stored position. The collapsed, stored position of the ladder 225 may allow a user of the automobile to easily transport the ladder with the vehicle 100.

To store the ladder 225, the length L of the ladder 225 may need to be reduced. As mentioned, the ladder 225 may fold onto itself to reduce its length L or it may telescope into itself to a reduced length L. For example, portions of the ladder 225 may store inside other portions of the ladder 225 such that the design is a telescoping design. The ladder 225 may lock in an extended position and in a telescoped position. The length L of the ladder 225 during storage should be small enough to easily store on the roof 110 of the vehicle 100. The storage length L of the ladder 225 may be approximately 10-20 percent of the extended length of the ladder 225. The length L of the ladder 225 may vary depending on vehicle make and model. For example, a larger vehicle may require a longer length L of the ladder 225 whereas a smaller vehicle may not have the need for same length and therefore may have a shorter length L.

As mentioned previously, the ladder 225 may be rotatably coupled to the cross beam system (e.g. cross beam system 205, FIG. 2). For example, the ladder 225 may be coupled to the rotatable member (e.g. rotatable member 220, FIG. 2) which may rotate about a portion of the cross beam system. The rotatable member may enable the ladder 225 to move from an engaged position as shown in FIG. 3 to a stored position as shown in FIG. 4. The ladder 225 may lock in the stored position which may be approximately forty-five (45) degrees from the roof 110 of the vehicle 100. The stored position may also be any angle that may enable the ladder 225 to be stored away from the one or more sides 305 of the vehicle 100. The varying degree of locking angle may enable the ladder 225 to accommodate various sizes and locations of cargo which may be stored proximate the roof 110 of the vehicle 100. For example, snow equipment such as skis or a snowboard may enable the ladder 225 to be stored at a very small angle relative to the roof 110, such as ten to twenty (10-20) degrees. In contrast, a bicycle or canoe may cause the ladder 225 to be stored more in a forty-five (45) degree angle. If no cargo is proximate the roof 110, the ladder 225 may rest directly on the roof 110. This may be beneficial if the vehicle 100 is stopped. However, if the vehicle 100 is moving the ladder 225 may vibrate and bounce on the roof 110 causing undesirable noises to occupants of the vehicle 100. Therefore, the ladder 225 should lock in place when the vehicle 100 is in motion to prevent this type of noise.

A spring-loaded collar (not shown) on the first or second attachment system (e.g. first or second attachment system 210, 215, FIGS. 1, 5, 6) may mate with complimentary teeth proximate the rotatable member (e.g. rotatable member 220, FIGS. 2, 5, 6). The collar may be fixedly retractable to allow for hands-free positioning. Once in position, the collar may be deployable to mate with the teeth in the rotatable member. This may lock the ladder in an engaged or stored position.

Further, in a stored configuration, the ladder 225 may rest on a cushioning surface 400 attached to the ladder 225 which may minimize potential stress to the collar device and which may protect the roof 110 of the vehicle 100. The cushioning surface 400 may be a semi-compressible material which may rest on the roof 110 of the vehicle 100 if the ladder 225 is stored on top of the roof 110. The cushioning surface 400 may comprise a weather-resistant material such as a polymer.

FIG. 5 is a close-up view of the cross beam system 205 and the load beams 145, 150 of the roof rack system 105. The cross beam system 205 as shown may include a portion of the ladder 225 and elements of the cross beam system 205. The first load beam 145 may be either the forward or aft roof rack such that the ladder 225 may be mounted on either the driver or passenger side of the vehicle 100. In some embodiments, a single vehicle may additionally be fitted with a ladder system on both the driver and passenger side of the vehicle 100.

The cross beam system 205 may comprise a first attachment 210, a second attachment 215, and a rotatable member 220. The first and second attachment may attach the ladder system 200 to the roof rack system 105. The first and second attachment 210, 215 may be complimentary and/or may be symmetrical. The first attachment 210 may comprise an insertion beam 500, an extension beam 505, and a corner joint 510 connecting the insertion beam 500 and the extension beam 505 together. The insertion beam 500 and extension beam 505 may be substantially transverse to each other.

The insertion beam 500 may insert into a hollow portion of the load beam 145. For example, the insertion beam 500 may have an outer diameter which may be less than an inner diameter of the load beam 145. This may allow a user to easily slide the insertion beam 500 into the hollow portion of the load beam 145. The insertion beam 500 may insert into the load beam 145 enough to provide structural support to the overall ladder system 200. The insertion beam 500 may insert at least twenty percent (20%) into the load beam 145. In some embodiments, the insertion beam 500 may insert a greater percentage into the load beam 145. The insertion length may vary depending on make and model of the vehicle as well as number of ladder systems installed.

The extension beam 505 may extend from the corner joint 510 towards the opposing load beam 150. In some embodiments, the extension beam 505 may be a single piece connecting to the corner joint 510 of the second attachment 215. In another embodiment as shown in FIG. 5, each extension beam 505 may extend only a portion of the distance between the two joints 510 such that there is a gap between a first extension beam 505 and a second extension beam 505-a.

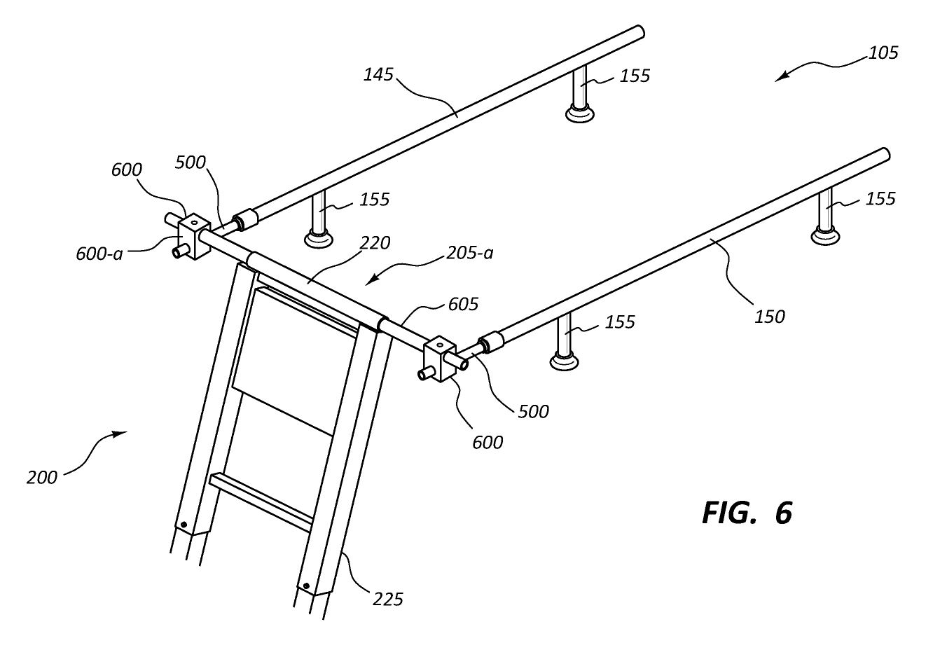

FIG. 6 is a close-up view of another embodiment of the cross beam system 205 and the load beams 145, 150 of the roof rack system 105. The cross beam system 205 as shown may include a portion of the ladder 225 and elements of the cross beam system 205. The first load beam 145 may be either the forward or aft roof rack such that the ladder 225 may be mounted on either the driver or passenger side of the vehicle 100.

The embodiment shown incorporates a different corner joint 600 with a single piece extension beam 605. The extension beam 605 couples a first corner joint 600 and a second corner joint 600-a. The rotatable member 220 may fit over the single piece extension beam 605. The corner joint 600 also represents a different configuration. The corner joint 600 may be box shaped with through holes that the extension beam 605 and insertion beam 500 may fit into. The through holes and extension beam 605 and insertion beam 500 may be tight fit such that an outer diameter of the extension beam 605 and insertion beam 500 is slightly larger than the inner diameter of the through holes. In another embodiment, the extension beam 605 and insertion beam 500 may be glued, screwed, or otherwise fixed to the corner joint 600.

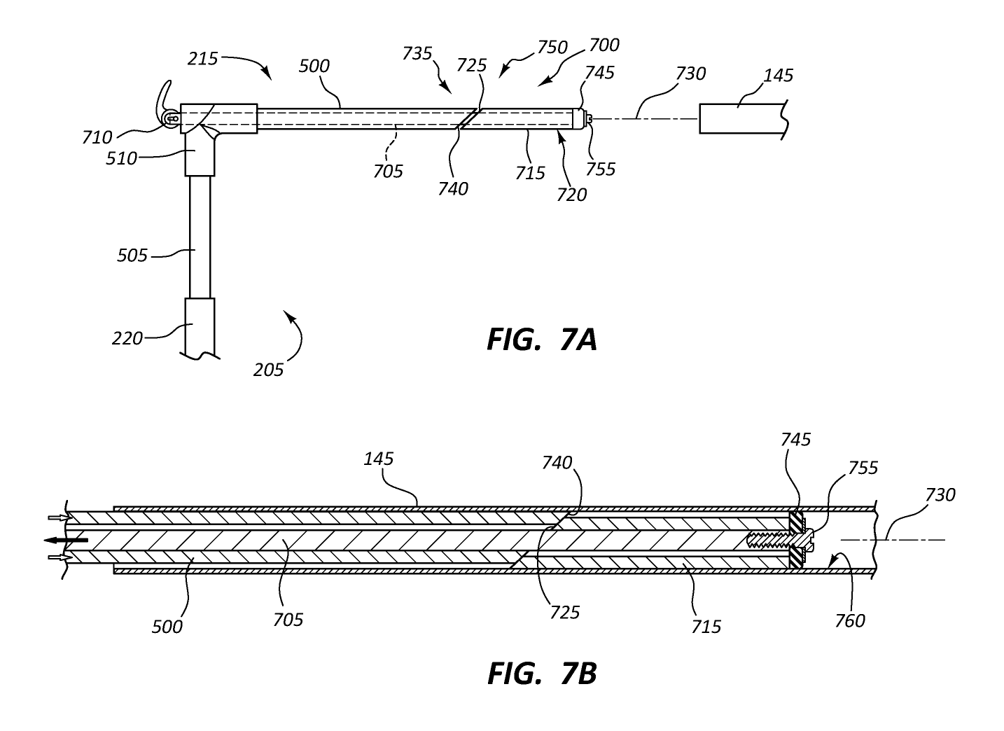

FIG. 7A is a top down view of the first attachment means 215, which is also representative of second attachment means. The first attachment means 215 may include an insertion beam 500, an extension beam 505, and a corner joint 510. The insertion beam 500 may include a locking mechanism 700 which may fasten the insertion beam 500 to a load beam (e.g. load beam, 145, 150).

The locking mechanism 700 may comprise a tightening mechanism 705 with a handle 710 and a compression mechanism 715. The compression mechanism 715 may create a tight fit between the inner diameter of the load beam and the outer diameter 720 of the insertion beam 500. The compression mechanism 715 may be a substantially cylindrical member with a diagonal surface 725 proximate the insertion beam 500. The diagonal surface 725 may be an angle between twenty (20) and seventy (70) degrees from an axis 730 aligned with the cylindrical member 720. An end 735 of the insertion beam 500 may have a complimentary diagonal surface 740 proximate the compression mechanism 715.

The tightening mechanism 705 may be couple to the compression mechanism 715. For example, the tightening mechanism 705 may attach to a washer 745 proximate a flat end of the compression mechanism 715. The tightening mechanism 705 may be a threaded member which may pass through a hole in the washer 740 and attach to a nut 755 on the opposite side of the washer 740. The tightening mechanism 705 may then pass through a hollow portion of the insertion beam 500 and through a hole 750 in the corner joint 510. The tightening mechanism 705 may then attach to the handle 710.

The handle may cause the tightening mechanism 705 to rotate. This may bring the compression mechanism 715 towards the insertion beam 500. Shown in FIG. 7B, as the opposing diagonal surfaces 725, 740 meet, the compression mechanism 715 may push against an inner diameter 755 of the load beam 145. This may cause the insertion beam 500 to lock against load beam 145 which may hold the cross beam system in place. The handle 710 may enable quick adjustment of distance F. Altering distance F may aid in the use of the ladder as discussed with reference to FIG. 3.

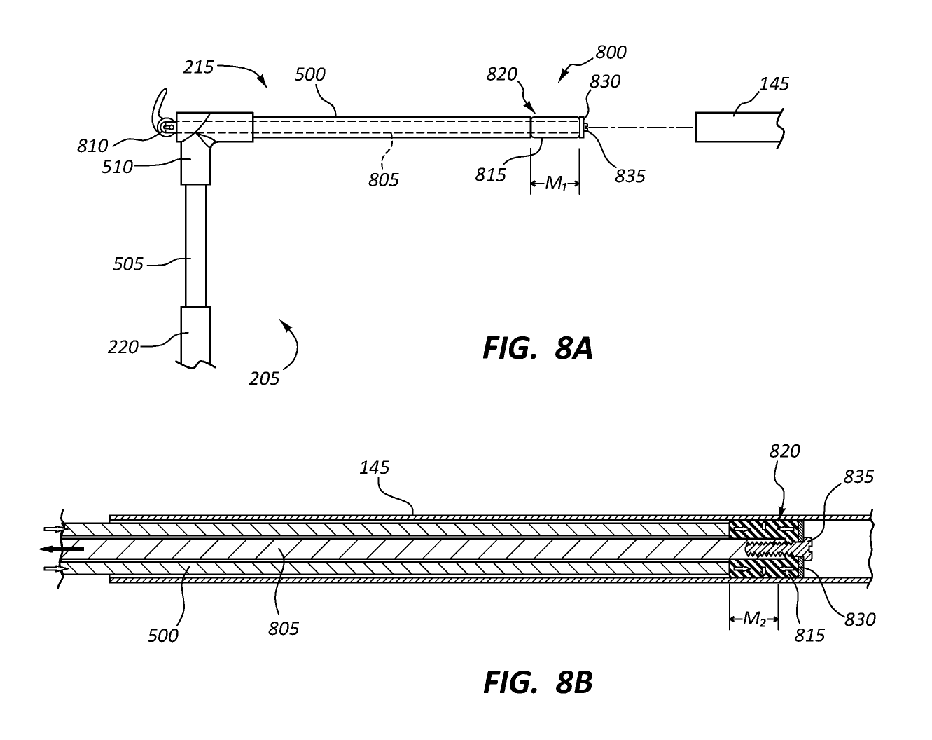

FIG. 8 is a top down view of the first attachment means 215, which is also representative of second attachment means. The first attachment means 215 may include an insertion beam 500, an extension beam 505, and a corner joint 510. The insertion beam 500 may include another embodiment of a locking mechanism 800 which may be coupled to the insertion beam 500 to a load beam (e.g. load beam, 145, 150).

The locking mechanism 800 may comprise a tightening mechanism 805 with a handle 810 and a compression mechanism 815. The compression mechanism 815 may create a tight fit between the inner diameter of the load beam and the outer diameter 820 of the insertion beam 500. The compression mechanism 815 may be a substantially cylindrical member comprising a compressible material. The compression mechanism 815 may have a first diameter when not engaged.

The tightening mechanism 805 may be coupled to the compression mechanism 815. For example, the tightening mechanism 805 may pass through a hole 825 in the compression mechanism and attach to a washer 830. The tightening mechanism 805 may be a threaded member which may pass through a hole in the washer 830 and attach to a nut 835 on the opposite side of the washer 840. The tightening mechanism 805 may then pass through a hollow portion of the insertion beam 500 and through a hole 845 in the corner joint 510. The tightening mechanism 805 may then attach to the handle 810.

The handle 810 may cause the tightening mechanism 805 to rotate. This may cause a length M of the compression mechanism 815 to reduce and may cause the diameter 820 of the compression mechanism 815 to increase. Shown in FIG. 8B, as the compressible material is tightened against the end of the insertion beam 500, the compressible material may expand in diameter. The expansion may create a tight fit between the compression mechanism 815 and an inner diameter of the load beam 145.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

1. An apparatus for accessing a roof of a vehicle, the apparatus comprising:
a first attachment system coupled to a first load beam of a roof rack system;
a second attachment system coupled to a second load beam of a roof rack system;
a rotatable beam movably coupled to the first and second attachment system; and
a collapsible ladder coupled to the rotatable beam.

2. The apparatus of claim 1, wherein the first attachment system further comprises:
a first elongated member with a locking end;
a second elongated member;
an elbow joint coupling the first elongated member and the second elongated member.

3. The apparatus of claim 2, further comprising:
a locking mechanism proximate the locking end, the locking mechanism providing a friction fit between the first attachment system and the first load beam of the roof rack system.

4. The apparatus of claim 3, wherein the locking mechanism further comprises:
a tightening member;
a handle coupled to a first end of the tightening member; and
a compression mechanism coupled to a second end of the tightening member.

5. The apparatus of claim 4, wherein the handle is proximate the elbow joint and the tightening member passes through the elbow joint and first elongated member to connect to the compression mechanism proximate the locking end of the first elongated member.

6. The apparatus of claim 1, further comprising:
a first position of the collapsible ladder, wherein the first position stores the ladder on the roof of the vehicle; and
a second position of the collapsible ladder, wherein the second position enables a user to deploy the ladder to access the roof.

7. The apparatus of claim 6, wherein the ladder locks into place in a storage position.

8. The apparatus of claim 6, wherein the collapsible ladder has a first length in the first position and a second length in the second position.

9. The apparatus of claim 8, wherein the second length of the ladder is adjustable.

10. The apparatus of claim 1, wherein the collapsible ladder is a folding ladder.

11. The apparatus of claim 1, wherein the collapsible ladder is a telescoping ladder.

12. The apparatus of claim 1, wherein the collapsible ladder has a curved profile.

13. The apparatus of claim 1, wherein the rotatable member laterally slides between the first attachment system and the second attachment system.

14. A ladder system for accessing a roof of a vehicle, the system comprising:
an attachment system coupled to a first and second load beam of a roof rack system;
wherein the attachment system comprises:
a first elongated member with a locking end;
an extension member;
a first elbow joint coupling the first elongated member and the extension member;
a second elongated member with a locking end;
a second elbow joint coupling the second elongated member and the extension member;
a rotatable beam movably coupled to the extension member; and
a collapsible ladder coupled to the rotatable beam.

15. The system of claim 14, further comprising:
a first locking mechanism proximate the locking end of the first elongated member, the first locking mechanism providing a friction fit between the first elongated member and the first load beam of the roof rack system.

16. The system of claim 15, wherein the first locking mechanism further comprises:
a tightening member;
a handle coupled to a first end of the tightening member; and
a compression mechanism coupled to a second end of the tightening member.

17. The system of claim 14, further comprising:
a first position of the collapsible ladder, wherein the first position stores the ladder on the roof of the vehicle; and
a second position of the collapsible ladder, wherein the second position enables a user to deploy the ladder to access the roof.

18. The system of claim 14, wherein the collapsible ladder has a first length in the first position and a second length in the second position.

19. The system of claim 14, wherein the collapsible ladder has a curved profile.

20. An apparatus for accessing a roof of a vehicle, the apparatus comprising:
a first attachment system coupled to a first load beam of a roof rack system;
wherein the first attachment system further comprises:
a first insertion beam with a locking end;
a first extension beam;
a first elbow joint coupling the first insertion beam and the first extension beam;
a locking mechanism proximate the locking end, the locking mechanism providing a friction fit between the first attachment system and the first load beam of the roof rack system;
a second attachment system coupled to a second load beam of a roof rack system;
wherein the second attachment system further comprises:
a second insertion beam with a locking end;
a second extension beam;
a second elbow joint coupling the second insertion beam and the second extension beam;
a locking mechanism proximate the locking end, the locking mechanism providing a friction fit between the second attachment system and the second load beam of the roof rack system;
a rotatable beam movably coupled to the first and second extension beams; and
a telescoping ladder coupled to the rotatable beam
wherein the telescoping ladder comprises:
a first position of the collapsible ladder, wherein the first position stores the ladder on the roof of the vehicle; and
a second position of the collapsible ladder, wherein the second position enables a user to deploy the ladder to access the roof.
